(19) United States
(12) Patent Application Publication
(10) Pub. No.: US 2010/0197227 A1
(43) Pub. Date: Aug. 5, 2010

(54) HEADSET ASSEMBLY FOR BLUETOOTH UTILITIES

(75) Inventors: Joo Won Heo, Kyeongsangbuk-do (KR); Seung Chul Kim, Kyeongsangbuk-do (KR); Woo Hyk Kwak, Kyeongsangbuk-do (KR)

Correspondence Address: LOWE HAUPTMAN HAM & BERNER, LLP, 1700 DIAGONAL ROAD, SUITE 300, ALEXANDRIA, VA, 22314, US

(73) Assignee: GT TELECOM CO., LTD., Kumi, Kyeongsangbuk-do (unknown)

(21) Appl. No.: 12/519,031

(22) PCT Filed: Dec. 14, 2006
(86) PCT No.: PCT/KR06/05723

§ 371 Date: Apr. 21, 2010

(30) Foreign Application Priority Data
Dec. 14, 2006 (KR) 10-2006-0128165

(51) Int. Cl. H04M 1/00; H04B 7/00

(52) U.S. Cl. 455/41.2

(57) ABSTRACT

Disclosed is a headset assembly for Bluetooth equipment. The headset assembly (H) for Bluetooth communication with mobile communication equipment includes an earphone body part (20) and a main body part (30) provided individually and connected to each other such that the earphone body part (20) and the main body part (30) can be hingedly rotated relative to each other about a hinge shaft (10), a carrying cap (50) selectively coupled to the earphone body part (20) or the main body part (30), the carrying cap (50) constituting a housing body together with the earphone body part (20) and the main body part (30), and a means mounted to the housing body for generating a switching signal to electrically open and close the headset assembly. The means for generating the switching signal of the headset assembly (H) is selected among a hole switch which can be operated by the connection and disconnection between a sensitive magnet (Mg) and a magnetic force sensitive IC (C) selectively provided at the earphone body part (20) and the main body part (30) or the carrying cap (50) through the hingedly rotation of the earphone body part (20) and the main body part (30) relative to each other about the hinge shaft (10), such that the earphone body part (20) and the main body part (30) form an angle therebetween or the earphone body part (20) and the main body part (30) are arranged in a straight line, or through the attachment or detachment of the carrying cap (50), a mechanical switch, such as a micro switch, which can be pressed according to the hingedly rotation of the earphone body part (20) or the main body part (30) about the hinge shaft (10) or the attachment and detachment of the carrying cap (50), and a switch which can be turned on and off by the rotation of the hinge shaft (10).

### TECHNICAL FIELD

The present invention relates to a headset assembly for Bluetooth equipment, and, more particularly, to a headset assembly for Bluetooth equipment which is constructed to be suitably applied to communication equipment using Bluetooth, which is a wireless transmission system adopted in various kinds of mobile communication equipment, especially mobile communication equipment, such as mobile phones, and, in addition, which has a power saving function.

### BACKGROUND ART

In recent years, there have been widely used terminal means, such as earphones, adopting a ‘Bluetooth’ communication protocol, a low-power local distance wireless transmission protocol system, i.e., a ‘Bluetooth’ communication protocol, which is one of new wireless transmission systems.

In particular, headsets adopting a Bluetooth communication protocol applied to mobile communication equipment transmit a transmission sound and a reception sound at low power. Consequently, the headsets allow communication without the use of additional wires or cables. Also, the power consumption of the headsets is very small, and therefore, the usefulness of the headsets is very high to such an extent that the maintenance expenses of the headsets are negligible. Consequently, the headsets have been popularized. For this reason, various kinds of headsets adopting the Bluetooth communication protocol have been developed by famous manufacturing companies and placed on the market.

### DISCLOSURE OF INVENTION

### Technical Problem

An important standpoint of terminals, such as earphones or headsets, adopting the above-mentioned Bluetooth is that standby time of the terminals necessary to continue communication must be long and the carrying of the terminals must be convenient because the terminals are generally used as an auxiliary device for mobile communication equipment.

A conventional Bluetooth headset OH with a general structure is illustrated in FIG. 1.

The headset is a receiving terminal that reproduces a signal transmitted from a mobile phone H. The headset includes a receiving body 1 for receiving an internal circuit, a speaker 2 mounted to the receiving body 1, a microphone 3 connected to the receiving body 1 via a hinge arm 4 rotatably mounted to the receiving body 1 by a hinge 7, and a general telephone conversation switch 5 and a charge-purpose power connector 6, which are interfaces exposed from the receiving body 1.

However, the conventional headset has problems in that it is very inconvenient for a user to carry the headset and to put the headset in his/her pocket.

Also, the conventional headset has problems in that the telephone conversation switch is pressed by an external force, during the keeping of the headset in the pocket of the user, i.e., when the headset is not in use, whereby the headset is unintentionally operated, and therefore, the headset attempts to connect with the mobile phone, or resending dialing is performed, whereby unnecessary telephone conversation is carried out without the recognition of the user, and therefore, an excessive amount of telephone conversation charge is imposed on the user and the standby time is reduced due to the unnecessary power consumption.

Especially, after the conventional Bluetooth headset is set to be ON through the user's manipulation of a multifunction key, the headset is always in a standby mode, and therefore, the power of the headset is continuously consumed in the standby mode of the headset, with the result that the use time of the headset is extremely restricted.

A more serious problem of the conventional headset is that, when the Bluetooth function is turned ON by the user, an indication lamp, such as a light emitting diode (LED), is flashed to indicate only the use of the Bluetooth function, and therefore, the headset is frequently set to be in the standby mode even when the Bluetooth function is not used by the user.

This is caused by the design to mount both the manipulation switch and the indication lamp in the very small Bluetooth headset. Specifically, it is difficult to visually recognize the use (ON) state, the standby state, and the nonuse (OFF) state with ease through the use of the single function key and the indication lamp.

Therefore, if the user does not pay attention, the user cannot recognize whether the Bluetooth headset is currently in the standby state or the OFF state, with the result that the standby time of the headset is greatly reduced.

Also, the headset adopting the Bluetooth is generally provided with the power connector 6, through which the headset is charged through a personal computer, a mobile phone, or an additional power supply, such that the headset is constructed to be a small-sized device that can be carried by the user. When the headset is put in the pocket of the user, however, foreign matter, such as dust, may be introduced into the power connector 6, which is an exposed terminal part of the headset, with the result that poor contact is caused.

### Technical Solution

Therefore, there is required for a Bluetooth headset that can be conveniently carried and that can prevent the unintentional operation of the telephone conversation switch in the standby state and introduction of foreign matter into the power connector. It is an object of the present invention to provide a headset assembly for Bluetooth equipment that is capable of accomplishing the above objects while exhibiting portability and usability.

It is another object of the present invention to provide a headset assembly for Bluetooth equipment constructed in a structure in which the headset assembly can be bent such that a user can easily recognize a standby state of the headset assembly although the user does not know a plurality of difficult setting indications, such as blinking, continuous blinking, and change of blinking colors, of a conventional indication lamp, such as LED.

It is a further object of the present invention to provide a headset assembly for Bluetooth equipment constructed in a structure in which, when the standby state of the headset assembly is set by the bending operation of the headset assembly, the occurrence of an event operation is decided by a microcomputer, and the power saving operation is selectively or simultaneously performed through the switch to a power saving mode of a Bluetooth integrated circuit, thereby greatly increasing the use time of the headset assembly to more than 10 times, and therefore, greatly improving the usefulness of the Bluetooth.

### ADVANTAGEOUS EFFECTS

The headset assembly for Bluetooth equipment according to the present invention is constructed to satisfy the portability required when its use with mobile communication equipment and not to respond to a manipulation signal generated by the unintentional operation of a manipulation switch when the headset assembly is not in use. Consequently, the headset assembly for Bluetooth equipment according to the present invention has the effect of increasing the standby time, which is the most important technical standpoint, preventing the unintentional cross during the telephone conversation, preventing the increase of telephone conversation charge, and preventing the introduction of foreign matter into the power connector of the headset assembly.

Also, the headset assembly for Bluetooth equipment according to the present invention has the effect of exhibiting the portability and, in addition, the usefulness as an accessory.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating the exemplary shape and use of a conventional Bluetooth headset with a general structure;

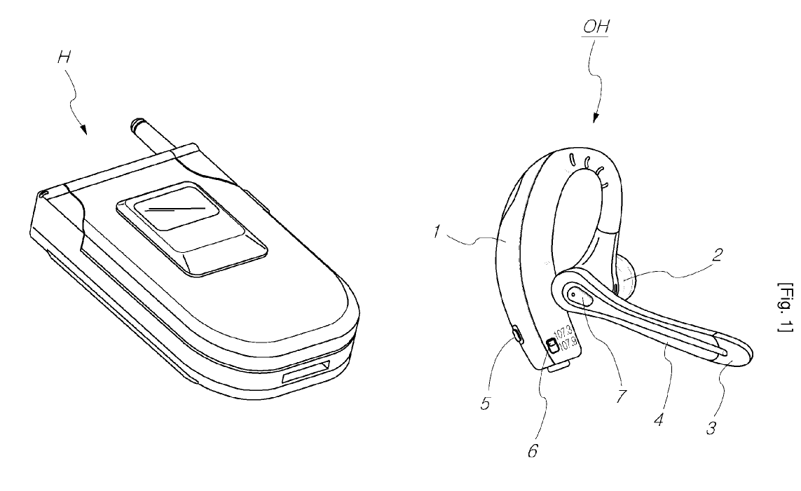

FIG. 2 is a perspective view illustrating the exemplary structure of a headset assembly for Bluetooth equipment according to the present invention, a carrying cap being removed from the headset assembly;

FIG. 3 is a perspective view illustrating a standby or operation mode of the headset assembly for Bluetooth equipment according to the present invention;

FIGS. 4A to 4C are a left side view, a front view, and a right side view respectively illustrating the headset assembly for Bluetooth equipment of FIGS. 2 and 3, and FIG. 4D is a right side view of the headset assembly for Bluetooth equipment when in use;

FIG. 5 is a perspective view illustrating the structure of another exemplary design to which the headset assembly for Bluetooth equipment according to the present invention is applied;

FIG. 6 is a perspective view illustrating a standby mode in which an earphone of FIG. 5 is on;

FIG. 7 is a view illustrating another exemplary power-saving structure of the headset assembly for Bluetooth equipment according to the present invention; and

FIG. 8 is a view illustrating an idle mode and an activation mode of a conventional headset for Bluetooth equipment.

### BEST MODE FOR CARRYING OUT THE INVENTION

In accordance with the present invention, the above and other objects can be accomplished by the provision of a headset assembly H for Bluetooth communication with mobile communication equipment, including an earphone body part 20 and a main body part 30 provided individually and connected to each other such that the earphone body part 20 and the main body part 30 can be hingedly rotated relative to each other about a hinge shaft 10, a carrying cap 50 selectively coupled to the earphone body part 20 or the main body part 30, the carrying cap 50 constituting a housing body together with the earphone body part 20 and the main body part 30, and a means mounted to the housing body for generating a switching signal to electrically open and close the headset assembly.

Preferably, the means for generating the switching signal of the headset assembly H is selected among a hole switch which can be operated by the connection and disconnection between a sensitive magnet Mg and a magnetic force sensitive integrated circuit (IC) C selectively provided at the earphone body part 20 and the main body part 30 or the carrying cap 50 through the hingedly rotation of the earphone body part 20 and the main body part 30 relative to each other about the hinge shaft 10, such that the earphone body part 20 and the main body part 30 form an angle therebetween or the earphone body part 20 and the main body part 30 are arranged in a straight line, or through the attachment or detachment of the carrying cap 50, a mechanical switch, such as a micro switch, which can be pressed according to the hingedly rotation of the earphone body part 20 or the main body part 30 about the hinge shaft 10 or the attachment and detachment of the carrying cap 50, and a switch which can be turned on and off by the rotation of the hinge shaft 10.

### MODE FOR THE INVENTION

Now, a headset assembly for Bluetooth equipment according to the present invention will be described in detail with reference to the accompanying drawings.

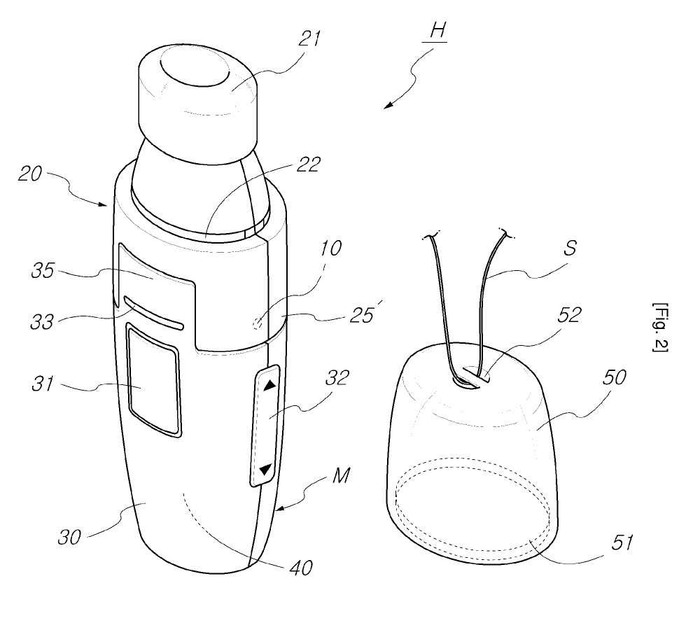

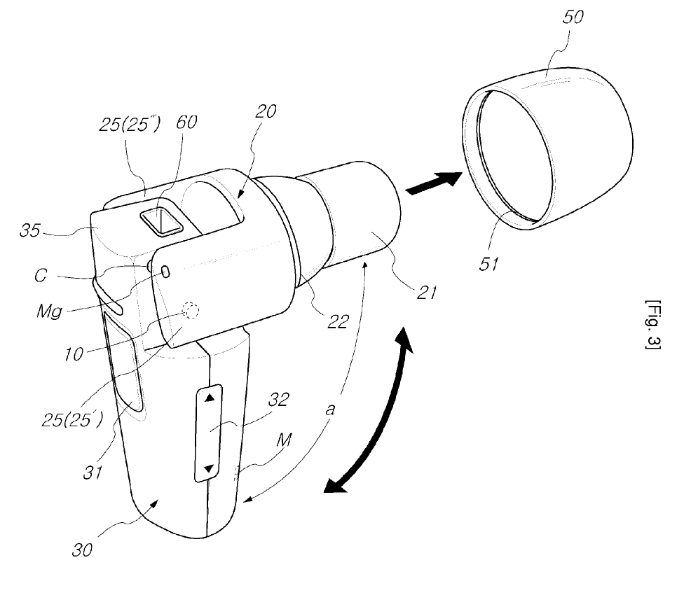

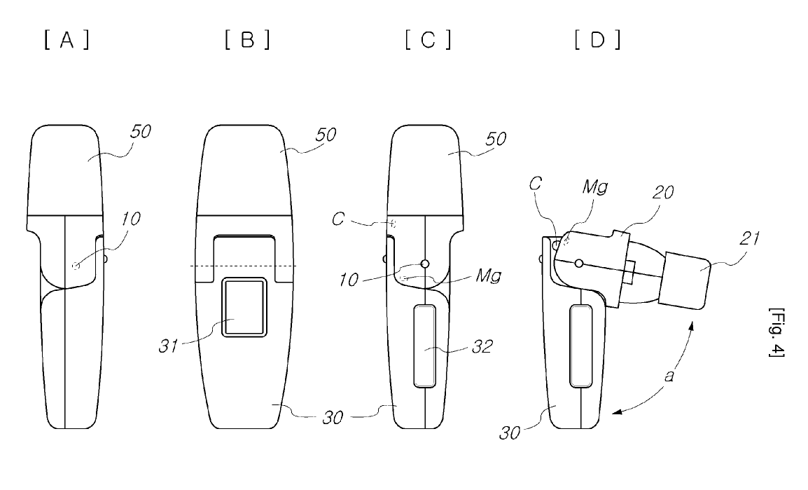

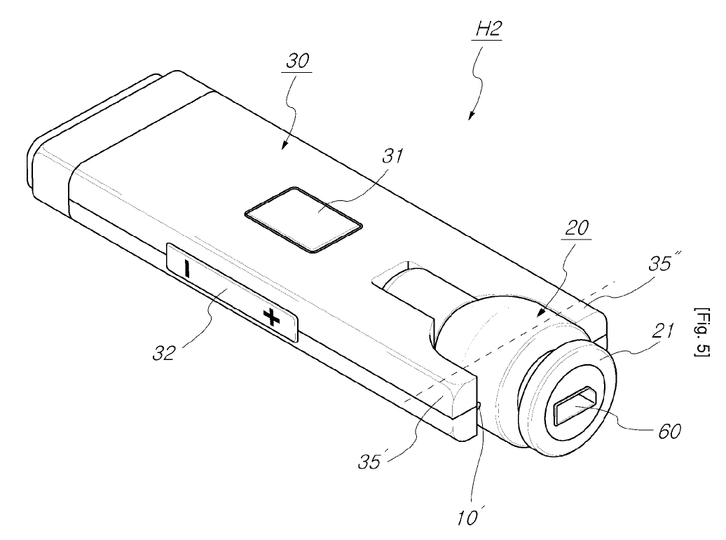

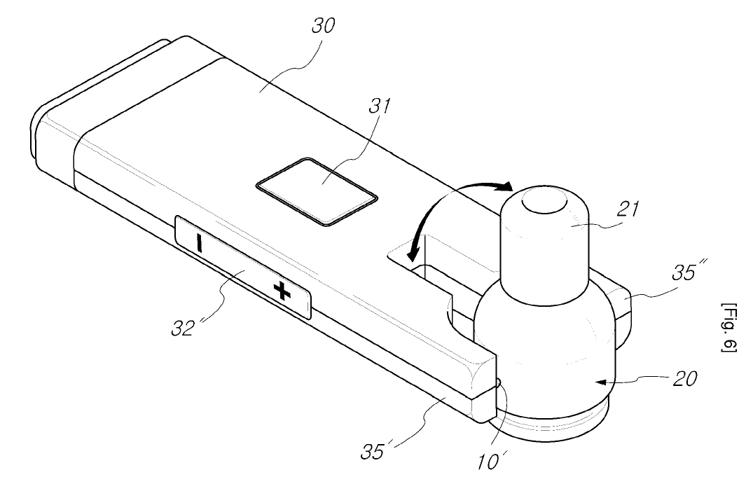

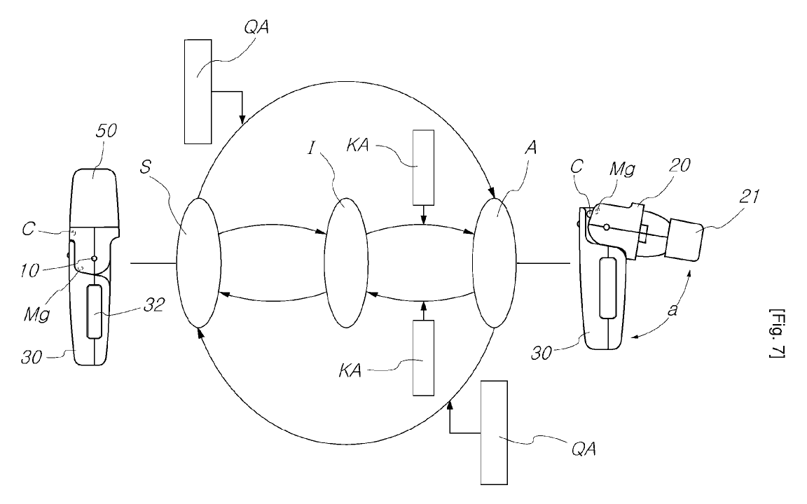

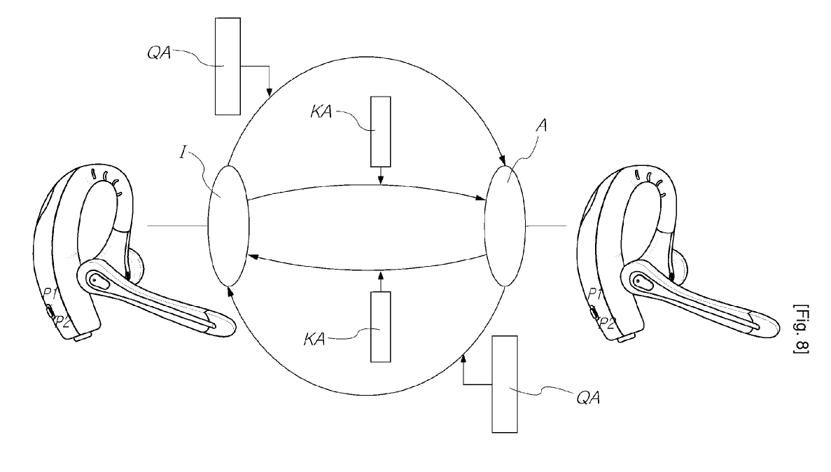

FIG. 2 is a perspective view illustrating the exemplary structure of a headset assembly for Bluetooth equipment according to the present invention, a carrying cap being removed from the headset assembly, FIG. 3 is a perspective view illustrating a standby or operation mode of the headset assembly for Bluetooth equipment according to the present invention, FIGS. 4A to 4C are a left side view, a front view, and a right side view respectively illustrating the headset assembly for Bluetooth equipment of FIGS. 2 and 3, and FIG. 4D is a right side view of the headset assembly for Bluetooth equipment when in use, FIG. 5 is a perspective view illustrating the structure of another exemplary design to which the headset assembly for Bluetooth equipment according to the present invention is applied, FIG. 6 is a perspective view illustrating a standby mode in which an earphone of FIG. 5 is on, FIG. 7 is a view illustrating another exemplary power-saving structure of the headset assembly for Bluetooth equipment according to the present invention, and FIG. 8 is a view illustrating an idle mode and an activation mode of a conventional headset for Bluetooth equipment.

The headset assembly H for Bluetooth equipment according to the present invention is basically characterized by the construction of a bendable rotary body and in that a manipulation switch for telephone conversation can be operated in a standby state in which the rotary body is bent.

As shown in FIG. 2, the headset assembly H includes an earphone body part 20 and a main body part 30 which are rotatable relative to each other about a hinge shaft 10.

The main body part 30 has a Bluetooth circuit board 40 mounted therein. Also, the main body part 30 has a microphone M, an indication lamp 33, a manipulation button 31, which is a multifunction switch to perform the beginning of telephone communication and termination of telephone communication, and a volume switch 32 (hereinafter, the manipulation button 31 and the volume switch 32 will be referred to as ‘manipulation switches’). In addition, the main body part 30 is provided at the upper end thereof with a hinge shaft part 35, which is an extension member protruding upward. At the end of the hinge shaft part 35 is mounted a power connector 60, which is exposed to the outside.

Through the cooperation of the above-described structure and another structure of the headset assembly, which will be described below, the power connector 60 of the main body part 30 is exposed to the outside only when the earphone body part 20 is hingedly rotated relative to the main body part 30, whereby the introduction of external foreign matter into the power connector is effectively prevented.

The advantage obtained by the separation of the earphone body part 20 from the main body part 30 is that the inactivation and activation of the manipulation switches, which will be described below, is easily performed.

In addition, an echo phenomenon (sound outputted from an earphone is transmitted to a microphone through an acoustic room defined in a housing of the headset, whereby the sound is transmitted to the other party as a reflected sound), which occurs in the conventional bar-type Bluetooth headset, is fundamentally solved by the provision of a pair of housing bodies which are completely divided from each other in the aspect of the acoustic room.

The earphone body part 20 has an earphone 21, which will be inserted into an ear of a user. The earphone 21 protrudes from the earphone body part 20 in an integrated fashion. At the bottom of the earphone body part 20 is formed an annular fitting groove 22, in which a carrying cap 50 is fitted.

As shown in the drawing, the carrying cap 50 is provided at the inner circumference thereof with an annular fitting protrusion 51, which is fitted in the annular fitting groove 22. Also, the carrying cap 50 is integrally formed with an insertion hole 52, through which a string S, such as mobile phone string or a necklace, is inserted. Alternatively, a coupling member (not shown), such as a tiepin, may be formed at the carrying cap 50 such that the carrying cap can be clipped to a pocket of a user for the purpose of carrying.

In order to construct the earphone body part 20 and the main body part 30 in a structure in which the earphone body part 20 and the main body part 30 can be hingedly rotated relative to each other, as shown in the drawing, the main body part 30 is provided with a hinge shaft part 35, which is a protruding shaft part that can be hingedly rotated about the hinge shaft 10, and the earphone body part 20 is provided with a hinge bridge part 25, formed approximately in the shape of ‘[’ to receive the hinge shaft part 35. The hinge bridge part 25 has a pair of hinge bridge pieces 25′ and 25″.

The earphone body part 20 and the main body part 30 are hingedly rotated relative to each other by a rotation angle a of approximately 70 to 110 degrees depending upon the convenience of a user. Consequently, when the earphone 21 of the earphone body part 20 is inserted into an ear of the user, the microphone M of the main body part 30 is located adjacent to the mouth of the user.

In order to prevent the headset assembly from returning to its original position after the hinged rotation between the earphone body part 20 and the main body part 30, the earphone body part 20 and the main body part 30 are preferably fixed to each other by a frictional force between the bridge piece 25′ of the hinge bridge part 25 and a bottom part 35′ of the hinge shaft part 35 and the mechanical interference between the bridge piece 25′ and the bottom part 35′ due to their sizes.

While the earphone body part 20 and the main body part 30 are hingedly rotated relative to each other, structures to apply power to the headset assembly H for Bluetooth equipment, such that the manipulation of the button is initiated, may be provided in various manners.

A structure having the highest operational reliability and a small possibility of breakdown is a hole switch. In this structure, a sensitive magnet Mg is inserted in the end of the bridge piece 25′ of the earphone body part 20, and a magnetic force sensitive integrated circuit (IC) C is mounted in the hinge shaft part 35 of the main body part 30 such that the magnetic force sensitive IC C is spaced apart from the sensitive magnet Mg in the state of FIG. 2 and FIG. 4C, in which the headset assembly is erected. Consequently, when the magnetic force sensitive IC C is spaced apart from the sensitive magnet Mg as shown in FIG. 2 and FIG. 4C, the microcomputer mounted in the circuit board 40 recognizes that the headset assembly is erected, and therefore, prevents the occurrence of a subsequent operation event although the manipulation button 31 and the volume switch 32 are pressed.

When the user hingedly rotates earphone body part 20 relative to the main body part 30, such that the headset assembly is bent, as shown in FIG. 4D, the sensitive magnet Mg approaches the magnetic force sensitive IC C, and therefore, a magnetic force is applied. As a result, the microcomputer recognizes the application of the magnetic force, and therefore, activates the manipulation button 31 and the volume switch 32 such that an event normally occurs by the user's pressing of the manipulation button 31 and the volume switch 32.

According to circumstances, the sensitive magnet Mg may be mounted in the carrying cap 50, and the corresponding magnetic force sensitive IC C may be mounted in the earphone body part 20.

The above-described structure of the sensitive magnet Mg and the magnetic force sensitive IC C may be applied to all kinds of Bluetooth headset assembly with the carrying cap 50.

Specifically, in addition of the structure in which the earphone body part 20 and the main body part 30 are hingedly rotated relative to each other about the hinge shaft part 35 as previously illustrated, the carrying cap may be fitted to an earphone part of a straight bar type headset or a headset permanently bent in the shape of ‘ [symbol] ’ and the magnetic force sensitive IC and the sensitive magnet may be mounted between the carrying cap and the earphone part of the headset. In this case, the headset has the same effect as the previously described headset assembly.

Alternatively, it is possible to consider a mechanical switch, such as a micro switch, in which an operation knob protrudes toward the hinge shaft part 35 such that the operation knob can be pressed by the rotation of the bridge piece 25′ about the hinge shaft 10, a mechanical switch, such as a micro switch, which is operated according to the attachment and detachment of the carrying cap 50, or a mechanical switch which is turned on and off by the rotation of the hinge shaft 10.

The carrying cap 50 allows the use of a string S for carrying and, in addition, prevents the introduction of external foreign matter into the earphone 21.

A headset assembly H2 shown in FIGS. 5 and 6 has the same concept as the previously described embodiment of the present invention; however, the headset assembly H2 of FIGS. 5 and 6 is characterized in that the length of the main body part 30 is greatly increased, and the size of the earphone body part 20 is extremely reduced such that the earphone body part 20 itself is received in the main body part 30 or the earphone is received in the main body part 30 by the hinged rotation of the earphone body part 20.

The same reference numerals refer to the same members or structures.

Hereinafter, the power saving function of the headset assembly for Bluetooth equipment with the above-stated construction according to the present invention will be described.

[Microcomputer's Recognition of Event by the Switching Due to the Bending]

When a user does not use the Bluetooth headset assembly H with the above-stated construction, the mechanical operation to hingedly rotate the earphone body part 20 relative to the main body part 30 of the headset assembly H is not performed, and therefore, the positional relationship between the earphone body part 20 and the main body part 30 is not changed. Consequently, the microcomputer chip, provided by ordinary manufacturing companies and mounted in the circuit board 40, recognizes the above-mentioned state, and therefore, prevents the occurrence of a subsequent operation event although the manipulation button 31 and the volume switch 32 are pressed.

When the user hingedly rotates the earphone body part 20 relative to the main body part 30 to use the headset assembly H, on the other hand, a switching signal generated by the mechanical operation and the change of the positional relationship between the earphone body part 20 and the main body part 30 is recognized by the microcomputer chip, and therefore, the microcomputer chip activates the manipulation button 31 and the volume switch 32 such that an event normally occurs by the user's pressing of the manipulation button 31 and the volume switch 32.

Consequently, it is possible for the user to easily recognize that the headset assembly H is in the standby state merely through his/her visual recognition of that the headset assembly H is bent in the shape of ‘ [symbol] ’

In addition to the structure disclosed as the switching means actuated by the bending and erecting operations as illustrated above, it is possible to determine whether the pressing operation of the manipulation switches is to be activated, such that the event can normally occur, or to be inactivated, such that the event cannot occur, by a switch means constructed to be operated by the opening and closing the carrying cap 50 or a switching means constructed to be turned on and off by the user's insertion and separation of an additional insertion pin, fixed to a string S, such as a mobile phone string or a necklace, into and from a fixing hole (not shown) formed at the headset assembly H. Such structures may be devises in various manners, and therefore, a detailed description thereof will not be given.

[Power Saving by Switching of Microcomputer Chip to Power Saving Mode]

As shown in FIG. 8, which illustrates a conventional Bluetooth headset, most Bluetooth headsets OH search a Bluetooth device (MASTER) of a mobile phone H at a predetermined period (500 ms to 800 ms) or transmit their own information to the mobile phone at regular intervals to continuously maintain the connection with the mobile phone such that the Bluetooth headsets immediately respond to the mobile phone H, in a standby mode, in which the telephone conversation is not performed, as well as in a telephone conversation mode.

As a result, a regular amount of power is consumed even in the standby mode. In the present invention, this state is referred to as a low-power idle state I.′ The Bluetooth headset OH may control an indication lamp, such as an LED, to blink in order to indicate that the Bluetooth headset OH is under the operation.

In addition to the low-power idle state I, as shown in FIG. 7, the present invention further includes a super low power state S in which the opening and closing operations are performed according to the above-stated various switching operation. In the super low power state S, the Bluetooth headset assembly H performs a sleep mode in which only an event, such as key input, is allowed but other functions are inactivated. As a result, the Bluetooth headset assembly H according to the present invention has standby time 10 times greater than that of the conventional Bluetooth headset.

The additional setting of the super low power state S is possible by the addition of simple logic in designing of the chip.

According to the present invention, the super low power state S is set according to a signal of the switching means, which can be constructed in various structures, constituting the Bluetooth headset assembly H, in a nonuse state, for example, at a state in which the earphone body part 20 and the main body part 30 of the headset assembly H are arranged in a straight line.

When a user hingedly rotates the earphone body part 20 of the headset assembly H relative to the main body part 30 to use the headset assembly H, the headset assembly H goes into the low-power idle state I. As a result, the headset assembly H is placed in the standby state, in which the headset assembly H is connected to a mobile phone, i.e., in which search and information exchange is periodically performed between the mobile phone and the headset assembly H. Consequently, the headset assembly H is maintained in the same state as the standby state of the conventional Bluetooth equipment. When a key action KA is performed by the user, i.e., the manipulation button 31, which is a multifunction switch, is manipulated by the user, the headset assembly H immediately goes into an activation state A in which the headset assembly H is maintained connected with the mobile phone to normally perform the Bluetooth function.

When a telephone call is received by the mobile phone in the super low power state S of the headset assembly H, the user may hingedly rotate the earphone body part 20 relative to the main body part 30, without the manipulation of the manipulation button 31, which is a multifunction switch, to connect the headset assembly H to the mobile phone such that the telephone communication is immediately performed. Consequently, the convenience of use is improved.

Even when the user hingedly rotates the earphone body part 20 relative to the main body part 30, such that the earphone body part 20 and the main body part 30 of the headset assembly H are arranged in a straight line, not to use the headset assembly H, and therefore, the signal from the switching means is interrupted, the headset assembly H does not directly go into the low-power idle state I, but the headset assembly H is disconnected from the mobile phone in a predetermined period of time and then the headset assembly H goes into the standby state.

This is to prevent the malfunction of the headset assembly H due to the frequent connection and interruption of the headset assembly H by the repetitive bending and restoring of the headset assembly H according to the present invention, irrespective of the intension of the user.

### INDUSTRIAL APPLICABILITY

As apparent from the above description, the present invention provides a headset that can be suitably applied to and used with mobile communication equipment, such as mobile phones. Furthermore, the present invention provides a headset assembly having a power saving function.

1. A headset assembly (H) for Bluetooth communication with mobile communication equipment, comprising:
an earphone body part (20) and a main body part (30) provided individually and connected to each other such that the earphone body part (20) and the main body part (30) can be hingedly rotated relative to each other about a hinge shaft (10);
a carrying cap (50) selectively coupled to the earphone body part (20) or the main body part (30), the carrying cap (50) constituting a housing body together with the earphone body part (20) and the main body part (30); and
a means mounted to the housing body for generating a switching signal to electrically open and close the headset assembly.

2. A headset assembly (H) for Bluetooth communication with mobile communication equipment, comprising:
a straight bar type headset or a headset permanently bent in the shape of ‘-|;’
a carrying cap fitted to an earphone part of the headset; and
a switching means mounted between the carrying cap and the earphone part of the headset, the switching means including a magnetic force sensitive integrated circuit (IC) and a sensitive magnet.

3. The headset assembly according to claim 1, wherein the means for generating the switching signal of the headset assembly (H) is selected among:
a hole switch which can be operated by the connection and disconnection between a sensitive magnet (Mg) and a magnetic force sensitive IC (C) selectively provided at the earphone body part (20) and the main body part (30) or the carrying cap (50) through the hingedly rotation of the earphone body part (20) and the main body part (30) relative to each other about the hinge shaft (10), such that the earphone body part (20) and the main body part (30) form an angle therebetween or the earphone body part (20) and the main body part (30) are arranged in a straight line, or through the attachment or detachment of the carrying cap (50);
a mechanical switch, such as a micro switch, which can be pressed according to the hingedly rotation of the earphone body part (20) or the main body part (30) about the hinge shaft (10) or the attachment and detachment of the carrying cap (50); and
a switch which can be turned on and off by the rotation of the hinge shaft (10).

4. The headset assembly according to claim 2, wherein a power saving function is carried out according to validity-invalidity of the occurrence of an event of the manipulation switch in a microcomputer chip of the headset assembly (H) depending upon whether the operation signal of the switching means exists or not.

5. The headset assembly according to claim 2, wherein a power saving function is carried out according to the switching between a low-power idle state (I) and a super low power state (S) of the headset assembly (H) depending upon whether the operation signal of the switching means exists or not.

6. The headset assembly according to claim 1, wherein the main body part (30) is provided at a region thereof which is exposed when the earphone body part (20) and the main body part (30) are hingedly rotated relative to each other with a power connector (60), whereby the power connector (60) is hidden while the earphone body part (20) and the main body part (30) are arranged in a straight line.

7. The headset assembly according to claim 1, further comprising:
a carrying means for carrying the headset assembly (H), the carrying means being a tiepin fixed to the earphone body part (20), the main body part (30), or the carrying cap (50).

8. The headset assembly according to claim 3, wherein a power saving function is carried out according to validity-invalidity of the occurrence of an event of the manipulation switch in a microcomputer chip of the headset assembly (H) depending upon whether the operation signal of the switching means exists or not.

9. The headset assembly according to claim 3, wherein a power saving function is carried out according to the switching between a low-power idle state (I) and a super low power state (S) of the headset assembly (H) depending upon whether the operation signal of the switching means exists or not.
